(19) United States
(12) Patent Application Publication
(10) Pub. No.: US 2012/0235786 A1
(43) Pub. Date: Sep. 20, 2012

(54) Intelligent Enclosures

(75) Inventors: Dickory Rudduck, San Francisco, CA (US); John Freese, Chestnut Hill, MA (US); Anthony White, Vernon Hills, IL (US); Benjamin Ford, Bondi Beach (AU); Christopher Kelliher, Toronto (CA)

(73) Assignee: Telezygology, Inc., Chicago, IL (US)

(21) Appl. No.: 13/232,043

(22) Filed: Sep. 14, 2011

Related U.S. Application Data
(63) Continuation-in-part of application No. 12/881,772, filed on Sep. 14, 2010.

(30) Foreign Application Priority Data
Apr. 6, 2010 (US) PCT/US2010/030107

(51) Int. Cl. G05B 19/00

(52) U.S. Cl. 340/5.54; 340/5.7

(57) ABSTRACT

The invention provides a system for controlling access for a storage enclosure. The storage enclosure has one or more walls and an opening defined by at least one of the walls. There is a closure for the opening and a fastener adapted to hold the closure in a closed position relative to the opening and adapted to allow the closure to assume an open position relative to the opening upon receipt of a suitable signal. The system includes a user interface adapted to enable the suitable signal to be received by the fastener upon entry of an access code, means for generating the access code after delivery of an item into the storage enclosure, and means for transmitting the access code to a recipient for the item.

### CROSS REFERENCE TO RELATED APPLICATIONS

This application is a continuation in part of PCT/US10/30107 filed on Apr. 6, 2010 which was published in English and is incorporated herein by reference, PCT/US10/30107 claims priority from United States Provisional Application No. 61/166,868 filed on Apr. 6, 2009 and is incorporated herein by reference. This application is also a continuation in part of U.S. application Ser. No. 12/881,772 filed on Sep. 14, 2010 and is incorporated herein by reference.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### FIELD OF THE INVENTION

This invention relates to enclosures. In particular, this invention relates to the control of access to an enclosure, especially to an intelligent enclosure.

### BACKGROUND OF THE INVENTION

Arrays of lockers or similar enclosures are widely known and found in a variety of locations, such as in schools, public transportation depots, shopping malls, etc. There is a high demand to provide people a location to secure personal belongings. Current locker systems utilize a key lock, a combination lock, or a similar manual locking system for providing security to the locker space. The problem is that keys go missing and combination codes are forgotten thereby locking a user out of accessing his/her belongings. Therefore there is a demand for a keyless and combination free solution to locking an enclosure.

Safe delivery of packages and other items is problematic if the recipient is not available to accept delivery. The delivery person may be required to attempt delivery on more than one occasion before being successful. Each attempt at delivery is costly to the deliverer and reduces profit and efficiency. Security is an issue if packages are not delivered safely.

Different types of packages may be delivered to recipients at various locations, in one example, packages are delivered to residents of apartment buildings. In this situation, a delivery person from a delivery service typically drops off a group of packages at the front desk of the apartment building where the packages are stored. When the recipient of the package returns to the apartment building, they can ask an attendant at the front desk for any packages that have been delivered during the day. The delivery person may leave a note at the recipient's door indicating that delivery was attempted and reminding the recipient to pick up the package,

This delivery approach suffers from various problems. To mention one shortcoming, a human attendant is required to receive and sign for the package. This can be costly for many apartment buildings to provide. This delivery approach also relies on the presence of the human attendant and/or the recipient to complete the delivery process. More specifically, the attendant has to retrieve the packages to give to the recipient. The packages are often unsorted and the attendant has to take time to find the correct package once the recipient arrives.

In addition, the recipient often has to periodically check to see if ⁻there are any packages waiting for them at the front desk. Further, the packages are often in an unsecured location which is susceptible to unauthorized entry and package theft. Package theft is a very common form of delivery theft, especially in locations where packages are not secured in a locked location until recipient pick--up. Records of package delivery, if they are maintained at all, are often hand-written and prone to error. Consequently, efficient management of package deliveries is difficult or impossible to achieve.

There have been some proposals to provide lockers, often in the form of an array of lockers, where the user allows access to delivery services or vendors. In each case, the user must assign an access code to the delivery service or the vendor before these deliverers can access the locker. The user has its Own, pre-assigned, access code or key for the locker, the locker being dedicated to the user. This type of proposal restricts the type of deliverer to those selected by the user and is not easily adapted to most delivery systems, like a postal system or large courier system, where a relatively small number of deliverers will wish to deliver to a very large number of recipients. In many circumstances, the recipient has not ordered or anticipated the item to be delivered and will not have set up an access code for the deliverer. Common examples are delivery of gifts or other unsolicited but welcome items.

It is an object of the present invention, at least in some embodiments, to provide a system for controlling access to a storage enclosure which can overcome drawbacks of prior art systems or which at the very least can offer a usable alternative.

### SUMMARY OF THE INVENTION

Accordingly, in a first aspect, this invention provides a system for controlling access for a storage enclosure, the storage enclosure having one or more walls and an opening defined by at least one of the walls, a closure for the opening and a fastener adapted to hold the closure in a closed position relative to the opening and adapted to allow the closure to assume an open position relative to the opening upon receipt of a suitable signal, the system including a user interface adapted to enable the suitable signal to be received by the fastener upon entry of an access code, means for generating the access code after delivery of an item into the storage enclosure, and means for transmitting the access code to a recipient for the item.

For convenience in the description below, in the system of the invention the storage enclosure may often be described as a locker having four watts defining an opening, the closure being a door for the opening. However, it is to be appreciated that the scope of the invention is not limited to this embodiment: there need only be a single wall, for example, forming a tubular enclosure and the closure need not be a door—it may be a drawer as one example of an alternative. The closure may be any type of device or structure used to control access to an enclosure. For example, the closure may be a swinging door, gate, garage door, or sliding door, to mention a few examples.

The wall or walls and the closure may be made of any suitable material, including metal and/or plastic.

The storage enclosure may be part of an array of similar storage enclosures, of the same or of varying shapes and/or sizes. In one embodiment, the enclosure is secured with a first fastener disposed at a first end of the enclosure and a second fastener disposed at a second end of the enclosure. In this embodiment, the access code unlocks either the first fastener or the second locking fastener.

The fastener preferably includes material adapted to contract when activated. The material adapted to contract when activated is preferably shape memory alloy, more preferably wire. Shape memory alloys are known and are usually made predominantly or wholly of titanium and nickel. They may also include other material, such as aluminum, zinc and copper. A shape memory alloy is capable of adopting one shape below a predetermined transition temperature and changing to a second shape once its temperature exceeds the transition temperature. Conversely, when the shape memory alloy cools below the transition temperature, it is capable of adopting the first shape again. In connection with the various embodiments of the present invention, the shape memory alloy contracts when heated in situ. Shape memory alloy wire currently available, such as that sold under the trade mark Nitinol, is capable of contracting by about 3% when activated by heating.

Activation of the material adapted to contract when activated is preferably achieved through electrical resistance heating, with a wire teed to the fastener assembly. Activation of the shape memory alloy wire can be initiated from a central location, using hard wiring. It is also within the scope of this invention that the activation is initiated by remote means, such as a hand held tool operating through the use of any suitable form of energy, including microwave, electric magnetic, sonic, infra-red, radio frequency and so on,

The scope of the invention in its various aspects is not necessarily limited to the use of shape memory alloy. Other material may also be useful. Also, while activation may take place through heating, other means of activation may be suitable and are within the scope of this invention.

The signal which allows the closure to assume an open position relative to the opening of the enclosure may be transmitted wirelessly or through hard wiring via controlling electronics. Wireless transmission can occur through any acceptable means.

The controlling electronics preferably includes a computer with appropriate software. There may be more than one set of electronics arranged in a desired fashion to control the signal to the fastener. It is further preferred that signals or reports may be sent to and from the fastener and that other monitoring capabilities are included in the system of the invention.

The user interface is preferably located on the front of the locker or in the vicinity of a plurality of lockers. This interface is preferably in the form of a computer screen, either with a keypad or in the form of a touch screen. An suitable form of user interface may be used, including, a personal digital assistant, a cellular phone, or a personal computer. Other examples of user interface devices are possible.

The interface may have an input and an output. The interface may be configured to receive at the input an indication that an item is available for delivery to the intended recipient, an indication of the size dimensions or general size) of the item, and the identity of the intended recipient.

The means for generating the access code upon delivery of an item into the storage enclosure preferably includes a processor which is configured to both generate the access code and transmit it to the recipient.

The processor in this embodiment is coupled to the interface and is configured to determine an available enclosure based at least in part upon the item size and/or the identity of the intended recipient. In some approaches, the output is coupled to an Internet connection and the access code is transmitted to the recipient in an email via the Internet connection. In still other examples, the processor is configured to receive a payment from the recipient for use of the available enclosure via the input of the interface.

In still others of these embodiments, the system of the invention includes a local. network and a plurality of fasteners communicatively coupled to the local network. Each of the fasteners secures an enclosure. The system also includes a data entry device that is coupled to the local network; a wide area network that is coupled to the local network; and a system controller that is coupled to ⁻the wide area network.

In this embodiment, the data entry device is configured to receive an indication that an item is available for delivery to an intended recipient, an indication of the asset size, and the identity of the intended recipient. The system controller is configured to determine an available enclosure based at least in part upon the asset size and/or the identity of the intended recipient received from the data entry device via the wide area network. The system controller is further configured, when an enclosure is determined to be available for the item, to transmit an access code to the intended recipient via the wide area network. The intended recipient can use the access code to open the fastener that secures the available enclosure and obtain the item.

The wide area network may be one or more networks such as the Internet, acellular wireless network, and the plain old telephone system (POTS). Other examples of networks and combinations of networks are possible.

The local network may be a network such as a campus-wide network; a network covering a building or portions thereof or a network covering an office or portions thereof Other examples are possible. In this respect and as used herein, “local network” refers to a network (or combination of networks) that are limited in geographic scope to a local area such as a building, apartment complex, campus, military base, or the like. A local network provides less geographic coverage than a wide area network (that, for example, covers states or countries such as the Internet.

The access code may be transmitted to the recipient in a variety of different ways, preferably electronic. In one example, the access code is transmitted to the intended recipient via email. In another example, the access code is transmitted to the recipient over a wireless connection, such as an sins on a mobile phone. In another example, the access code may be transmitted on a set or possibly delayed schedule depending upon the user's needs, Access codes may also be encrypted upon transmittal. Other examples of transmission are possible.

In an especially preferred embodiment, the access code is a cell phone number of the recipient. In this embodiment, upon delivery of an item the deliverer may call the cell phone in order to transmit the access code or the system itself may call the cell phone. In either case, the system stores the cell phone number as the access code.

When the recipient receives the call, the recipient is notified that the item has been delivered. The cell phone message may include the address of the enclosure if this does not already belong to the recipient. The recipient approaches the enclosure which may be part of an array) and calls a telephone number of the system. This number is preferably clearly displayed on the enclosure or nearby, for example, on a banner at the top of the array. The system is configured to recognize the recipient's cell phone by its telephone number (access code) and allow the recipient access to the enclosure.

The method and system of the invention may be embodied in a relatively simple way combined with social networking, such as that facilitated by Facebook. For example, a person may wish to provide a gift for one or more friends, using an array of enclosures according to the invention. The person may deposit the gift or gifts in one or more enclosures and transmit an access code to each of the friends via Facebook. Each friend then accesses the enclosure and the gift using the assigned access code. This embodiment may be particularly effective if the access code is the cell phone number of each friend, as described above,

Optionally, a further access code may be required to enable a deliverer to open the enclosure and place the item therein. As a further option, the deliverer may be prompted to select the type of enclosure that is needed to house the item. Once that selection is made, the deliverer may deposit the item in the enclosure, close the closure and the enclosure will be locked via the fastener.

The deliverer may be another user who wishes to leave a package for a differentuser to pick up at a later date.

If desired, an administrator can be granted access to the enclosure or enclosures. This is particularly useful in emergency settings where is it imperative that a locker is opened, or in schools, for example, when teachers or other school officials must have access to a locker,

An electronic log of received items and intended recipients may be maintained. In some aspects, the log may be accessible to a system administrator at substantially all times.

This log may also maintain details of internal factors within the enclosure, such as weight, temperature, and other environmental factors.

When determining the available enclosure, a real-time determination of the identity of an enclosure may be made. The available enclosure may be an enclosure that is not currently being used by the recipient. In other aspects, the available enclosure may be an enclosure that is currently being used by the recipient. In still other aspects, the available enclosure may be an enclosure that is being shared by the recipient with another user. When the access code is entered to retrieve the item from the enclosure, a visual indicator may be employed to identify the correct enclosure to the recipient so that the recipient can easily locate the enclosure if it forms part of an array. The visual indicator may be a light, for example. In other embodiments, once the access code actuates the fastener to allow the closure to assume an open position, the closure may be pushed to open the enclosure to the recipient. Alternatively, the closure may be opened automatically (e.g., it may swing outwardly) upon receipt of the access code.

In other examples, an electronic log of received items and intended recipients may be maintained. In some aspects, the log is accessible to a system administrator at substantially all times. This log may also maintain details of internal factors within the enclosure, such as weight, temperature, and other environmental factors. In other aspects, the processor is further configured to maintain a log of received items and intended recipients in a memory storage device. In some examples, the log in the memory storage device is accessible to a system administrator at substantially all times.

In some examples, the recipient may pay for the enclosure. For example, the recipient may pay a predetermined cost for a predetermined time period allowing the recipient access to the space during that time period, pay higher costs for certain time periods, or pay higher costs for additional features (e.g., special indicator arrangements, additional electronic reminders, and so forth).

In some embodiments, the enclosure may be mobile and can be moved from one location to another easily. The enclosure may be on wheels or other suitable means to move the enclosure. Other examples of approaches the provide mobility are possible. As mentioned, the available enclosure may be in one of several usage states with respect to the recipient. For example, the available space may not be currently used by the recipient, may be currently used by the recipient, or may be currently shared by the recipient with another user.

In a second aspect, this invention provides, in a system for controlling access for a storage enclosure, the storage enclosure having one or more walls and an opening defined by at least one of the walls, a closure for the opening and a fastener adapted to hold the closure in a closed position relative to the opening and adapted to allow the closure to assume an open position relative to the opening upon receipt of a suitable signal, a shelf for the storage enclosure, wherein the fastener is mounted on or in the shelf and the shelf is adjustable. Preferably, the system includes a user interface adapted to enable the suitable signal to be received by the fastener upon entry of an access code, means for generating the access code after delivery of an item into the storage enclosure, and means for transmitting the access code to a recipient for the item.

By building the fastener into a shelf, this makes the system of controlling access to the storage enclosure may be easily retrofitted to many existing locker assemblies. One skilled in the art will recognize that this invention is also suitable for newly built locker assemblies.

Other advantages and aspects of the present invention will become apparent upon reading the following non-limiting description of the drawings and the detailed description of preferred embodiments of the invention,

### BRIEF DESCRIPTION OF THE DRAWINGS

FIG. 1 is a front elevation of an array of large and small storage enclosures, being lockers, with all closures in the closed position;

FIG. 2 is a view of the lockers of FIG. 1, but showing the closures in the open position;

FIG. 3 is a view similar to that of FIG. 1, but showing the lockers of uniform size, with the closures in closed position;

FIG. 4 shows the locker array of FIG. 3, with the closures in the open position;

FIG. 5 is a screen shot from a typical first screen of a user interface;

FIG. 6 is a screen shot of the user interface prompting for an access code;

FIG. 7 is a screen shot of the user interface relaying a message to a recipient picking up a package;

FIG. 8 is a screen shot of the user interface assisting a deliverer dropping off a package;

FIG. 9 is a screen shot of the user interface showing the deliverer that an access code has been sent to a recipient;.

FIG. 10 is a schematic view of an array of lockers controlled by multiple electronics;

FIG. 11 shows one of the lockers of FIG. 10 in the opened position;

FIG. 12 is a detailed view of an embodiment of a fastener in the open position.

FIG. 13 is a diagram showing an embodiment of the system of the invention;

FIG. 14 is a flowchart showing an embodiment of controlling access to an enclosure;

FIG. 15 is a block diagram showing an embodiment of apparatus for controlling access to an enclosure;

FIG. 16 is a block diagram showing a further embodiment of the system for controlling access to one or more enclosures according to invention;

FIGS. 17A-D are flowcharts showing an embodiment for controlling access to one or more enclosures areas according to the invention;

FIG. 18 shows one example of a series of display screens displayed during item drop off according to embodiments of the present invention; and

FIG. 19 shows one example of a series of display screens displayed during item pick-up according to embodiments of the present invention.

### DETAILED DESCRIPTION OF THE PREFERRED DRAWINGS

Skilled artisans will appreciate that elements in the Figures are illustrated for simplicity and clarity and have not necessarily been drawn to scale. For example, the dimensions and/or relative positioning of some of the elements in the Figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

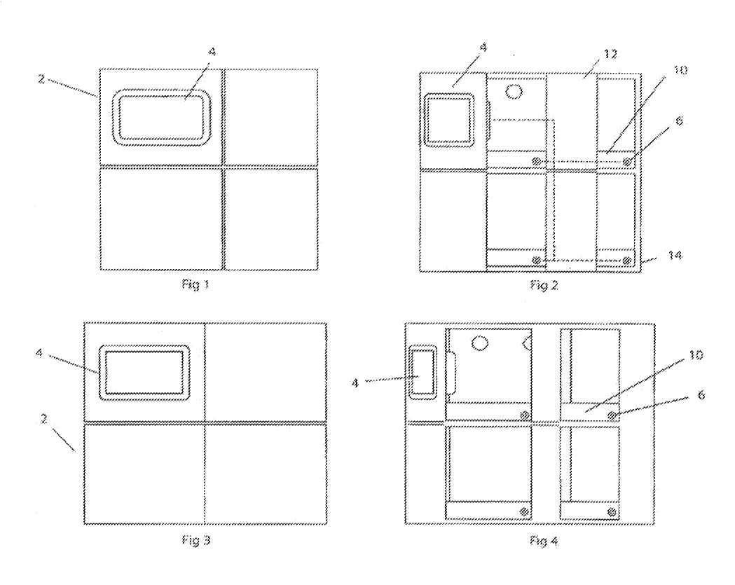

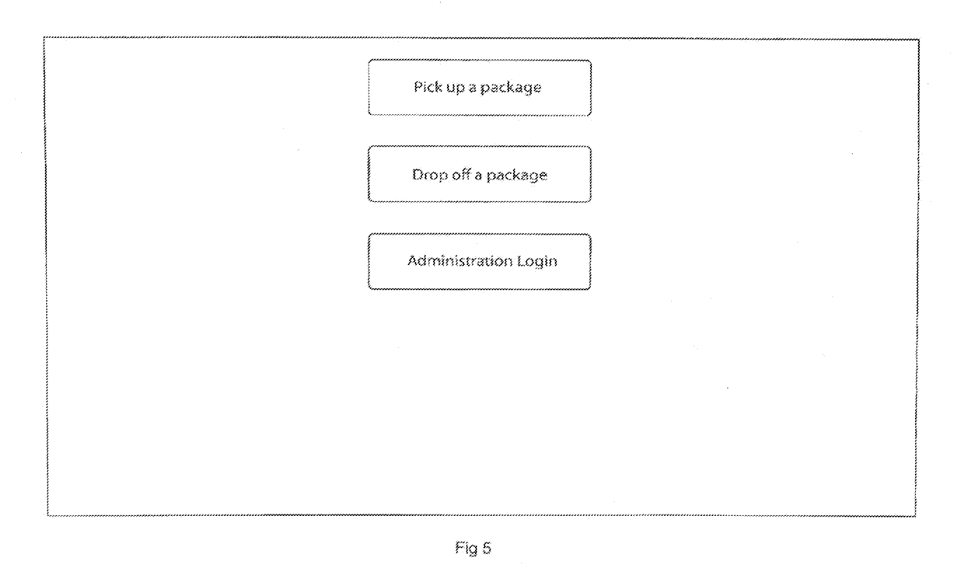

As shown in FIGS. 1-4 and 10-12, a plurality of storage enclosures is represented by lockers 2. Each locker 2 has walls, one of which is shown at 14, defining an opening 3. Closure 12 closes of opening 3 when in the closed or locked position (FIGS. 21 and 3) and allows access to locker 2 when in the open position (FIGS. 2 and 4)

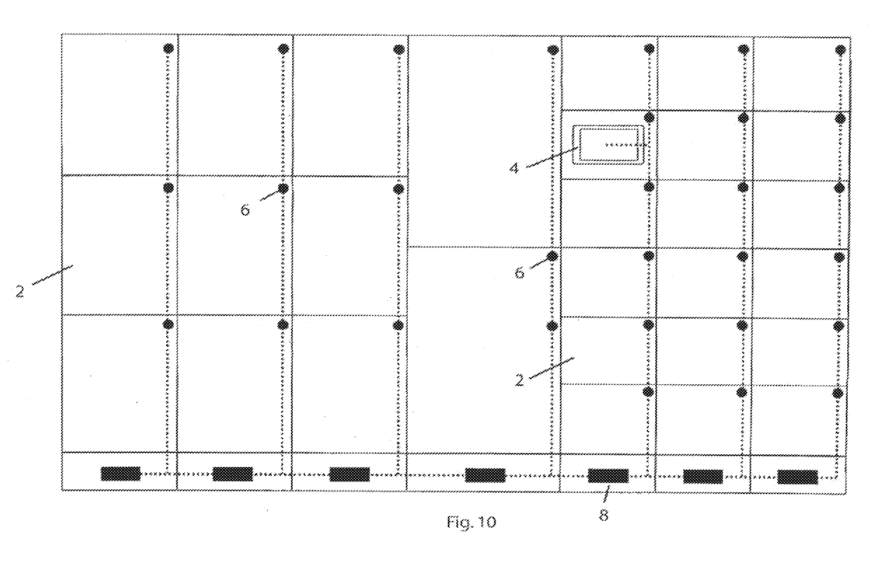

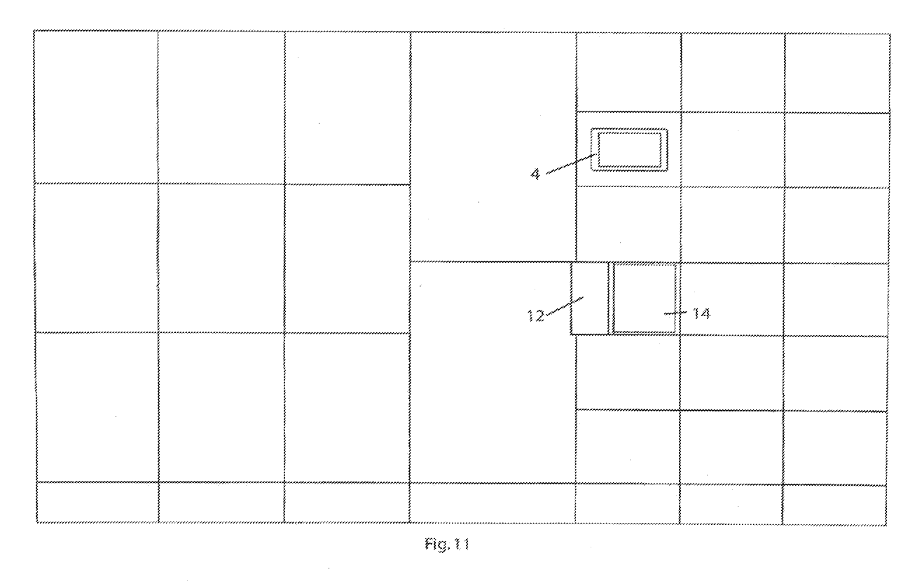

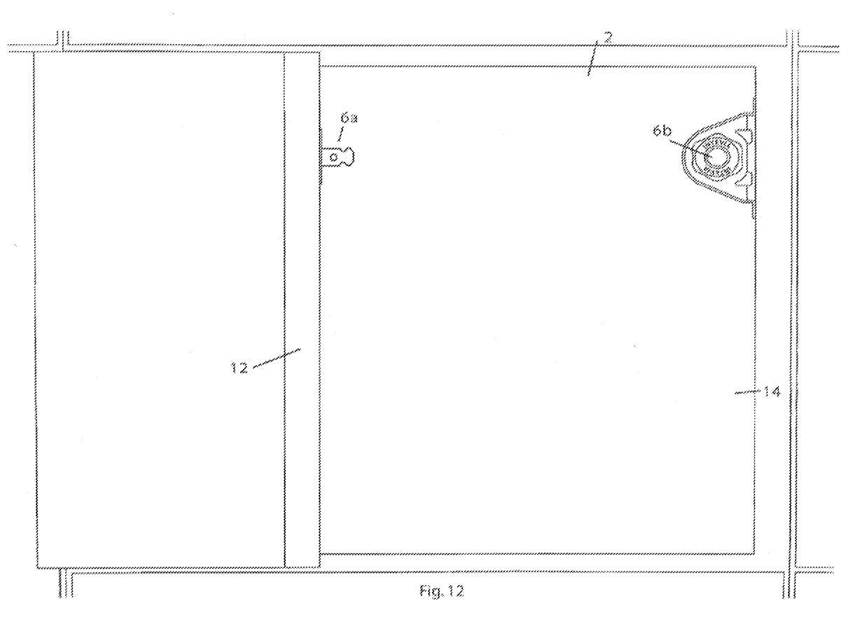

A fastener 6 holds closure 12 in the closed position. On the front of the locker 2 is a user interface 4. This user interface assists a user in accessing locker 2. The fastener 6 can be contained within an adjustable shelf 10 that is able to retrofitted into existing lockers 2 as seen in FIGS. 2 and 4. Alternately, fastener 6 may be built into locker 2 as seen in FIGS. 10-12.

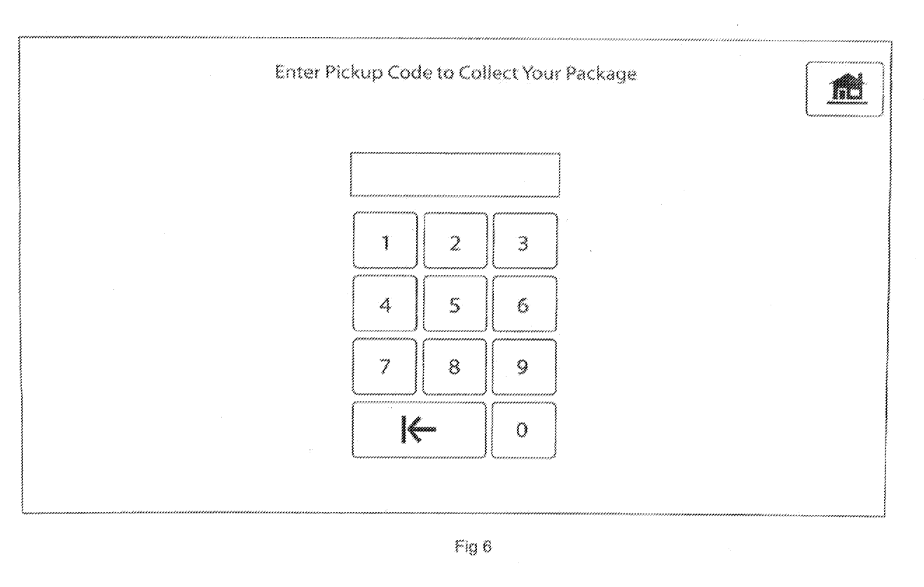

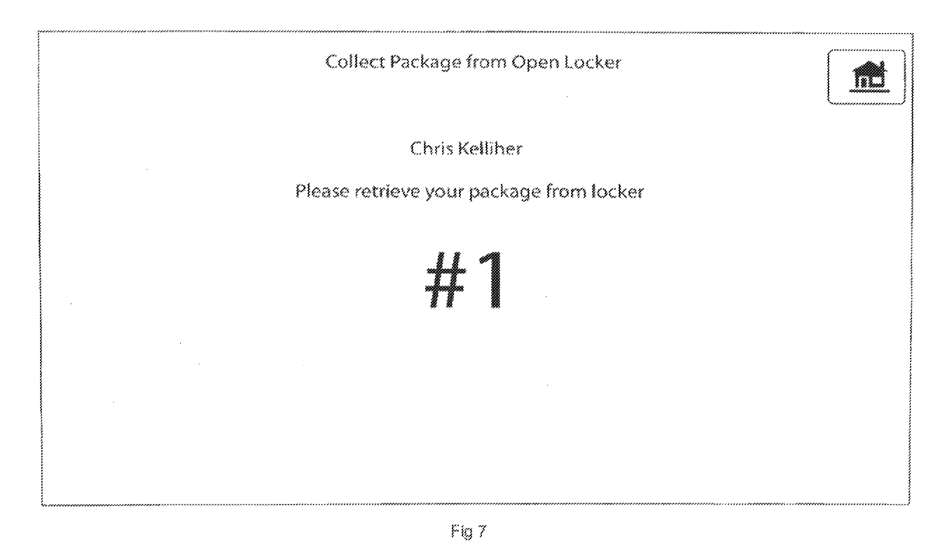

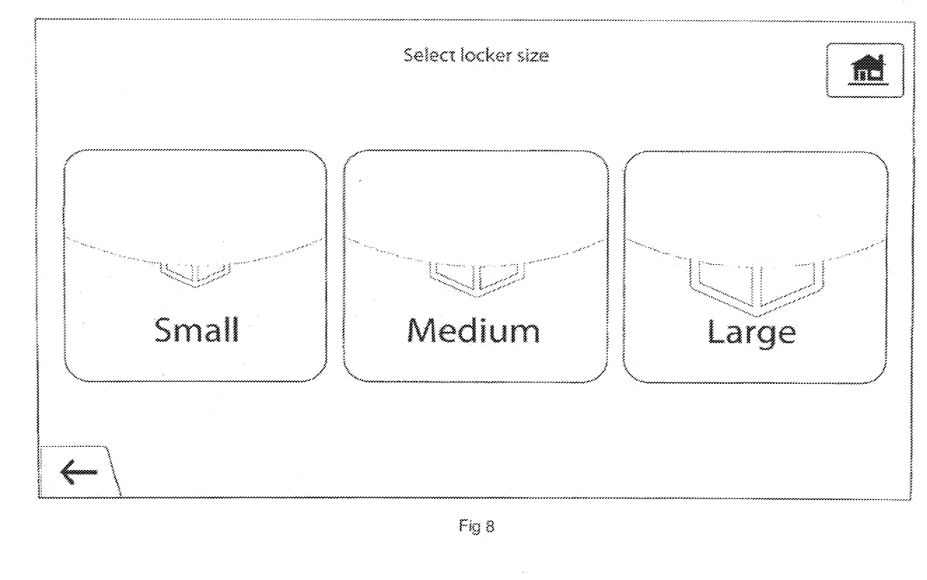

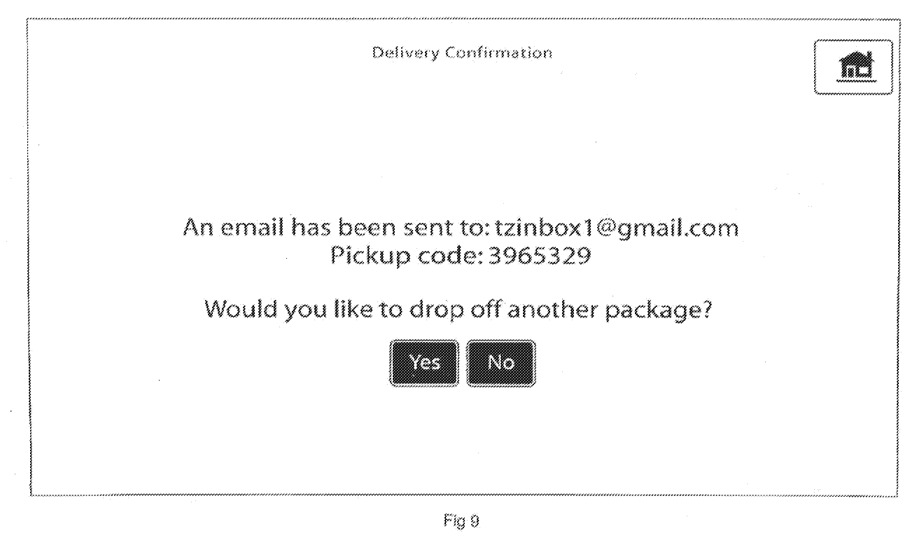

FIGS. 5-9 show preferred screenshots that may be displayed at the user interface 4. If a user desires access to a locker 2, then he/she must follow the prompts on the user interface 4. In situations where the locker 2 must be unlocked to access a package or other item, a user will release the fastener system through the user interface 4; the user interface will communicate with the fastener 6 via a signal from electronics 8 (FIG. 10) to cause fastener 6 to release closure 12 from wall 14, thus allowing the user access.

When the user needs to secure locker 2, closure 12 is joined to wall 14 by way of the fastener 6 joining its parts 6a and 6b (FIG. 12). Stud 6a is received into cavity 6b; the user interface 4 receives a signal via the controlling electronics 8 and responds appropriately by locking stud 6a into cavity 6b.

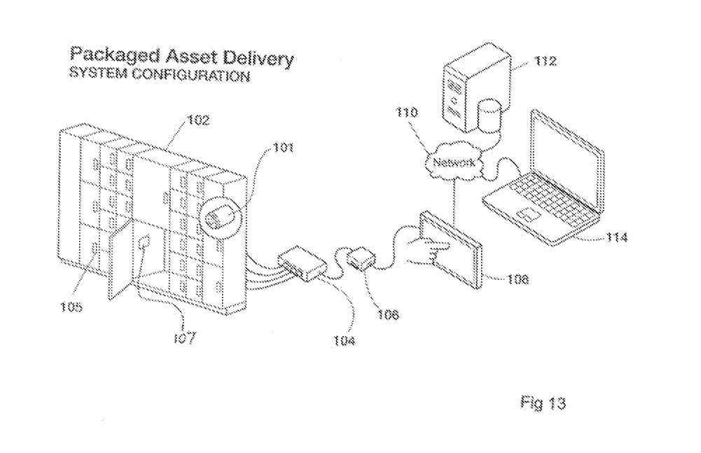

Referring now to FIG. 13, the system includes a locker system 102, a network hub 104, an interface controller 106, a data entry device 108, a network 110, memory storage 112, and an asset manager 114.

The locker system 102 is any type of storage arrangement where one or more storage spaces are secured by one or more locking arrangements. Each of the lockers has a locking arrangement (e.g., a fastener or electronic lock) that is communicatively coupled to the hub 104. The locking arrangements are actuated by reception of an access code that opens/releases the locking arrangement so as to allow a closure securing the storage space to be opened thereby allowing access to the storage space. For simplicity, only one locking arrangement 105 is identified in FIG. 13 although it will be appreciated that each locker has a locking arrangement. It will be further appreciated that the locking arrangement 105 may be coupled to the hub 104 by any type of connection such as wired connection, wireless connection, and optical connection, to mention a few examples.

The lockers may have one or more environmental control devices 107 that control, adjust, or otherwise affect one or more environmental or physical conditions within the locker. For example, the environmental control device 107 may adjust lighting, temperature, pressure, or any other condition within the locker. In this respect, the environmental control device 107 may be a fan, light, air conditioner, freezer unit, or heating unit. Other examples are possible. Control of the environmental control device 107 may be accomplished from the asset manager 114 or the interface 108. For example, conditions within the locker may be monitored (e.g., via sensors) and commands may be issued from the asset manager 114 or the interface 108 to operate the environmental control device 107 and maintain various conditions within the locker within predetermined limits.

The network hub 104 is any type of network hub that connects the many connections from the locker system 102 to a single output connection coupled to the interface controller 106. The hub 104 may also provide for power distribution to the locker system 102.

The interface controller 106 is an interface connection that converts signals from one communication protocol to another. In one example, the controller 106 converts signals between a USB-type protocol and the RS-485 protocol. Other communication protocols and other types of conversions can also be used.

The user interface or data entry device 108 is any type of data entry device. The data entry device may be a device such as a touch screen device, a personal digital assistant, a cellular phone, and a personal computer. Other examples of data entry devices are possible. In the example of FIG. 13, the data entry device is a touch screen device.

The network 110 is any type of computer network including any type of local network, micro network, or wide area network. Combinations of these networks may also be used. If the network 110 is a wide area network, the wide area network may be one or more networks such as the Internet, a cellular wireless network, or the plain old telephone system (POTS). Other examples of wide area networks are possible.

If the network 110 is a local area network, the local network may be a network such as a campus-wide network; a network covering a building or portions thereof; or a network covering an office or portions thereof. Other examples of local networks are possible.

The memory storage 112 may be any type of memory storage device used to store information regarding the locker storage 102. For example, logs describing items that were delivered and/or intended recipients may be stored in the memory storage 112.

The asset manager 114 may be any combination of hardware/software that manages information related to the locker system 102 and the available storage spaces in the locker system 102. It may generate reports of available space, usage, and so forth. These reports may be stored in the memory storage 112 or communicated to an administrator (or others) for viewing via the network 110.

In one example of the operation of the system of FIG. 13, a delivery person delivers an item or packaged asset and enters an indication that a packaged asset is available for delivery to an intended recipient at the device 108. Alternatively, the delivery person may provide the packaged asset to another person (e.g., an attendant at the front desk of an apartment complex) and that person may perform the packaged asset delivery actions described below. The packaged asset as described herein may be a package (large, small, medium, oversized an envelope, or any other type of item.

The delivery person also enters an indication of a size of the asset and an identity of the intended recipient at the device 108. The size may be a general size (e.g., large, small, medium, oversized) or may be one or more dimensions or a weight). The device 108 determines an available storage space in the lockers 102 based at least in part upon the size of the asset and the identity of the intended recipient. When a storage space is determined to be available for the packaged asset, an access code is transmitted from the device 108 to the intended recipient via the network 110 allowing the intended recipient to access the available storage space using the access code. The access code, in one example, is a randomly generated number. The locking arrangement 105 of the locker system 102 may be programmed to accept this access code and allow this access code to open the locking arrangement 105. The asset manager 114 may create and maintain a log of transactions and store these in memory storage 112.

To retrieve the packaged asset, the recipient may go to the device 108, enter the code, and thereby access the packaged asset in the assigned locker. The access code may actuate a locking arrangement that allows or causes a closure (e.g., a locker door) to be opened. The code entered by the recipient may be compared to a list of acceptable codes at the device 108. An indicator 101 may alert the user as to the correct locker. The indicator may be an LED in one example. There may be an indicator for a group of lockers, or one indicator for each locker. The color of the indicator may change depending upon the state of the secured space. For example, one color may be used when the locker is closed, another color for another action such as the indicator flashing) when the recipient accesses the space, and still another color when the secured space is opened.

In some examples, the available storage space in the lockers 102 is secured with a first locking arrangement disposed at a first end of the storage space and a second locking arrangement disposed at a second end of the storage space. The access code unlocks one of the first locking arrangement or the second locking arrangement. This allows a delivery person to use one door to access the storage space and the recipient to use a second door to access the same space. Advantageously, these doors may be disposed opposite to each other.

The door of the locker 102 securing the available storage space may be pushed to open once the code allows access. This prevents the door flying open and causing potential injury to the recipient. Alternatively, the door may be opened automatically upon receiving the access code.

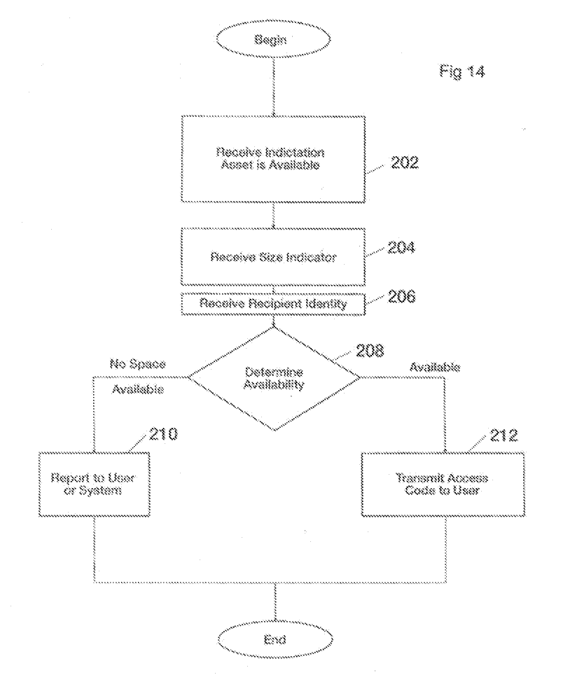

Referring now to FIG. 14, one example of an approach for controlling access to a secured area is described. At step 202, an indication that a packaged asset is available for delivery to an intended recipient is received. For example, a delivery person may enter this via a touch screen or some other data entry device. In another example, at least some of this information may be scanned in (e.g., scanning an RFID tag). At step 204, an indication of a size of the asset is received. As with step 202, a delivery person may enter this information via a touch screen or some other data entry device. At step 206, an identity of the intended recipient is received. In another example, at least some of this information may he scanned in (e.g., scanning an RFID tag). As with steps 202 and 204, a delivery person may enter this information via a touch screen or some other data entry device in another example, at least some of this information may he scanned in (e.g., scanning an RFID tag).

At step 208, an available storage space is determined based at least in part upon the size of the asset and the identity of the intended recipient. For instance, a determination may be made if a space is available and the identity of that space. If there is no available space, at step 210 a report/message is sent to the recipient and/or the system administrator. At step 212, when a storage space is determined to be available for the packaged asset, an access code is transmitted to the intended recipient allowing the intended recipient to access the available storage space using the access code.

When determining the available storage space at step 208, a real-time determination of the identity of a storage space may be made. The available storage space may be a storage space that is not currently being used by the recipient. In other aspects, the available storage space may be a storage space that is currently being used by the recipient. In still other aspects, an available storage space may be a storage space that is being shared by the recipient with another user.

The access code may be used to access the available storage space and retrieve the packaged asset from the available storage space. A visual indicator (e.g., LED) may be deployed to identify the available storage space to the recipient. This indicator may also be used during the package delivery process to indicate to the deliverer the location of the storage space where to store the packaged asset.

The access code may be transmitted to the recipient at step 212 in a variety of different ways. In one example, the access code is transmitted to the intended recipient via email across the Internet. In another example, the access code may be sent to a cellular phone or personal digital assistant of the user via a wireless network. Other examples of delivery approaches are possible.

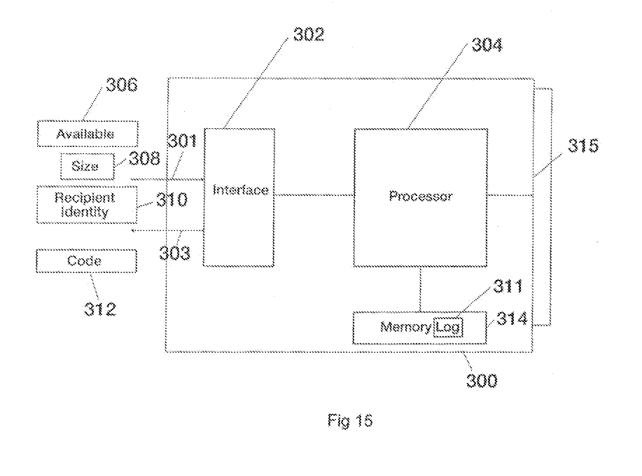

Referring now to FIG. 15, one example of an apparatus 300 for controlling access to a secured area is described. The apparatus 300 includes an interface 302 and a processor 304. The interface 302 has an input 301 and an output 303 and is configured to receive at the input 301 an indication 306 that a packaged asset is available for delivery to an intended recipient, an indication 308 of asset size, and an identity 310 of the intended recipient.

The processor 304 is coupled to the interface 302 and is configured to determine an available storage space based at least in part upon the asset size 308 and the identity of the intended recipient 310. The processor 304 is further configured, when a storage space is determined to be available for the packaged asset, to transmit an access code 312 to the intended recipient at the output 303 of the interface 302 allowing the intended recipient to access the available storage space using the access code 312.

In other aspects, the processor 304 is further configured to maintain a log 311 of received packaged assets and the intended recipients in a memory storage device 314. In some examples, the log 311 in the memory storage device 314 is accessible to a system administrator at substantially all times.

In some approaches, the output 303 is coupled to an Internet connection and the access code 312 is transmitted to the recipient in an email via the Internet connection. In still other examples, the processor 304 is further configured to receive a payment from the recipient for use of the available storage space via the input 301 of the interface 302.

The apparatus includes a touch screen 315 that is coupled to the processor 304. The touch screen 315 allows a delivery person (or attendant) to enter delivery information (e.g., that a package is available, the package size, and/or the intended recipient). The screen 315 also provides an interface for the package recipient to enter the access code the retrieve the packaged asset. The memory 314 may also store a list of possible recipients that can be displayed on the screen 315. The input 301 and output 303 may be coupled to the locking arrangements and to other networks/network elements.

It will be understood that the apparatus 300 may be a wide variety of devices. For example, the apparatus 300 may be a touch screen device. In other examples, the apparatus 300 may be a personal computer and the screen 315 may be disposed at a personal computer.

It will be appreciated that the elements shown in FIG. 15 may be housed in a single and compact housing unit that can be located near a storage center (e.g., a locker arrangement). This allows the apparatus 302 to be disposed in compact areas. However, some or all of the elements may be moved to other and separate locations (e.g., to a system controller that controls locking arrangements via a wide area network).

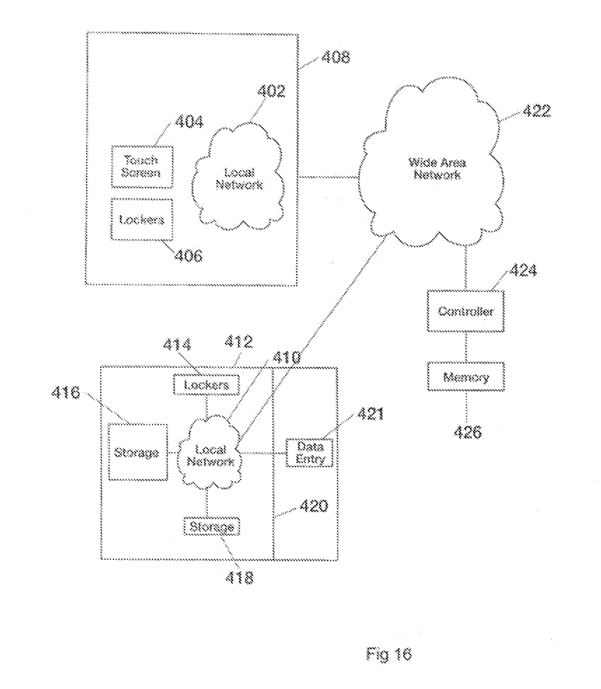

Referring now to FIG. 16, one example of a system for controlling access to one or more secured areas is described. The system 400 includes a first local network 402 and a plurality of locking arrangements (e.g., electronic locks) at lockers 406. These locking arrangements are communicatively coupled to the first local network 402. Each of the plurality of locking arrangements 406 secures a storage space. A data entry device (e.g., touch screen) 404 is coupled to the local network 402. A wide area network 422 is coupled to the local network 402 and a system controller 424 is coupled to the wide area network 422. The local network 402, touch screen 404 and lockers 406 may be disposed in a first building 408.

A second local network 410 is coupled to locking arrangements at lockers 414, locking arrangements at storage facility 416, locking arrangements at storage facility 418, and a data entry device 421. Each of the lockers 414, storage facility 416, and storage facility 418 includes individual secured storage areas (e.g., lockers) that are secured by one or more of the respective locking arrangements. The data entry device (e.g., a touch screen device 421 is coupled to the local network 410. The local network 410, data entry device 421, lockers 414, storage facility 416, and storage facility 418 may be in a second building 412.

The data entry devices 404 and 421 are configured to receive an indication that a packaged asset is available for delivery to an intended recipient, an indication of asset size, and an identity of the intended recipient. For example, a delivery person or attendant may enter this information via the particular data entry device 404 or 421. The system controller 424 is configured to receive this information (that is transmitted to the controller 424 via the local area networks 402 or 410, and the wide area network 422) and determine an available storage space based at least in part upon the asset size and the identity' of the intended recipient.

The system controller 424 is further configured, when a storage space is determined to be available for the packaged asset, to transmit an access code to the intended recipient via the wide area network 422. For example, the access code may be emailed to the intended recipient, or sent to the recipient's cellular phone or personal digital assistant. The intended recipient can use the access code to open the locking arrangement securing the available storage space and obtain the packaged asset. More specifically, the recipient may go to the data entry device 404 or 421 and enter the code.

The wide area network 422 may be one or more networks such as the Internet, a cellular wireless network, or the plain old telephone system (POTS). Other examples and combinations of wide area networks are possible.

The local networks 402 or 410 may be networks such as campus-wide networks, networks covering a building or portions thereof, or networks covering an office or portions thereof Other examples of local networks are possible.

The data entry devices 404 or 421 may be a device such as a touch screen device, a personal digital assistant, a cellular phone, and a personal computer. Other examples of data entry devices are possible.

It will be understood that some or all of the functions of the controller 424 may be moved to the data entry device 404 or 421. For example, the code-generating function in the controller 424 may be moved to the touch screen 404 or 421 In some examples, all functions are moved and the system controller need not be used. In other aspects, the data entry devices 404 and/or 421 may be moved to be coupled to the locking arrangements without being coupled to an intervening local network.

A log of recipients, drop off times, and recipients may be maintained at a memory 426 that is coupled to the controller 424. Other types of information and other types of reports may be generated at the system controller 424 and stored at the memory 426.

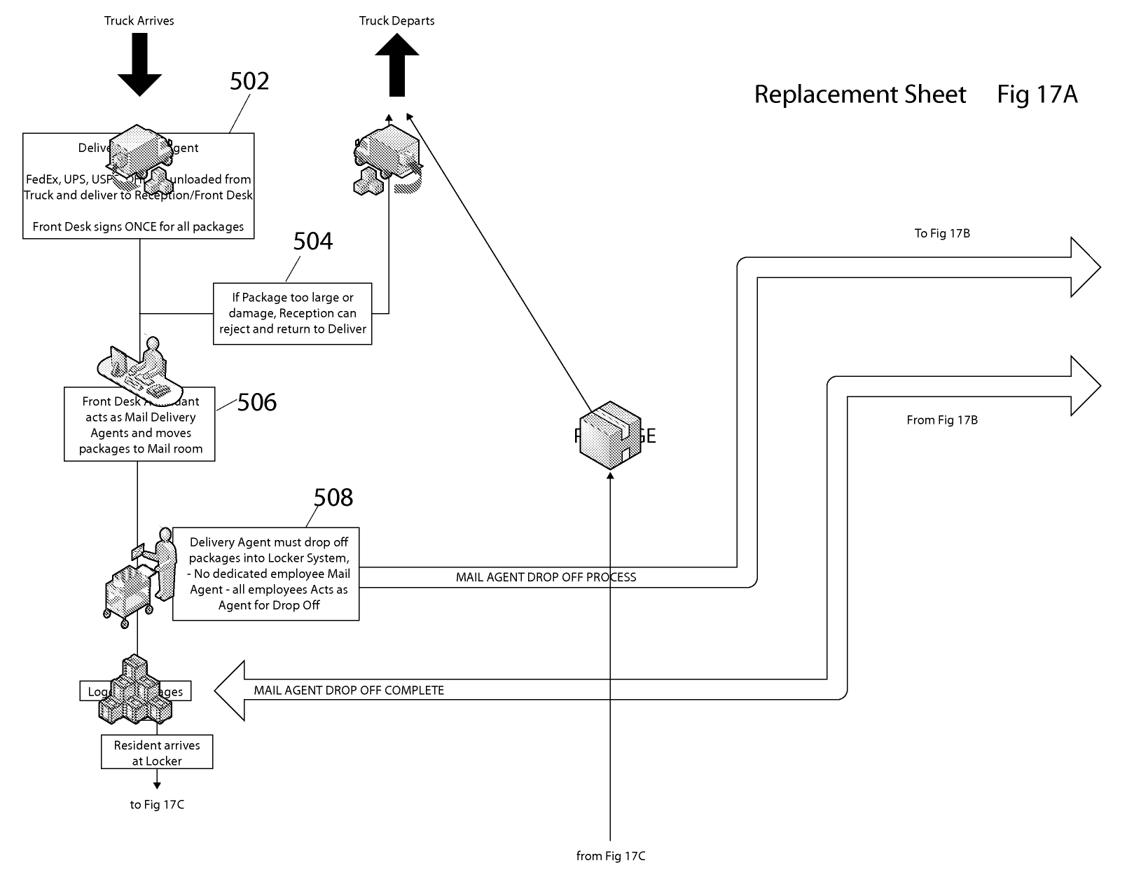

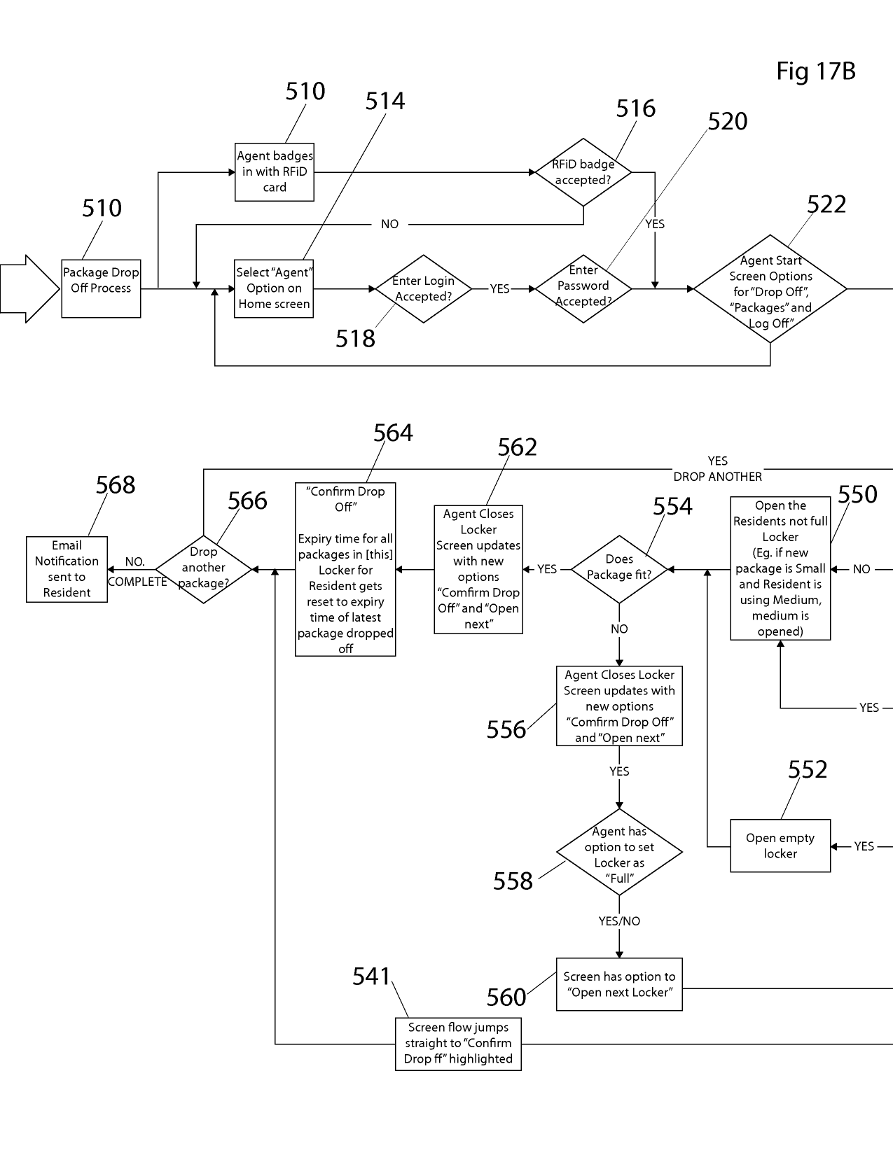

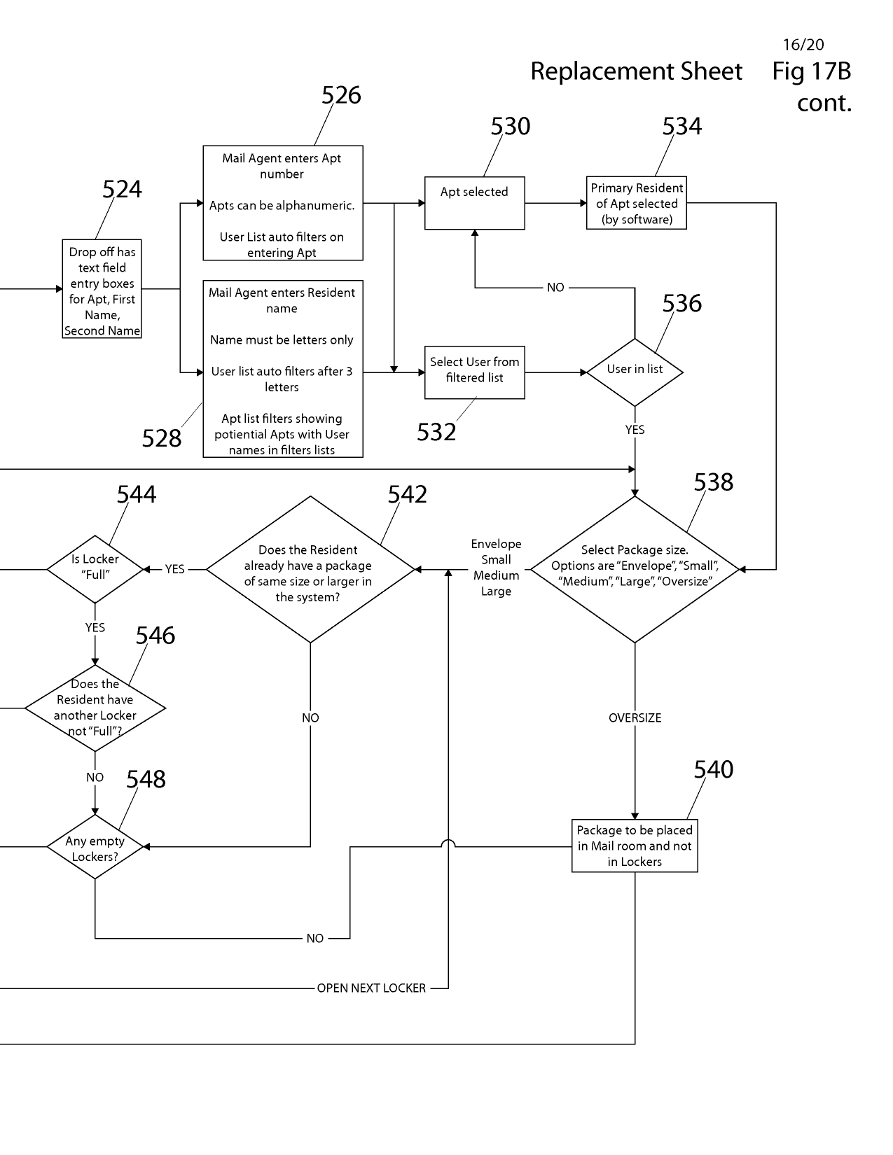

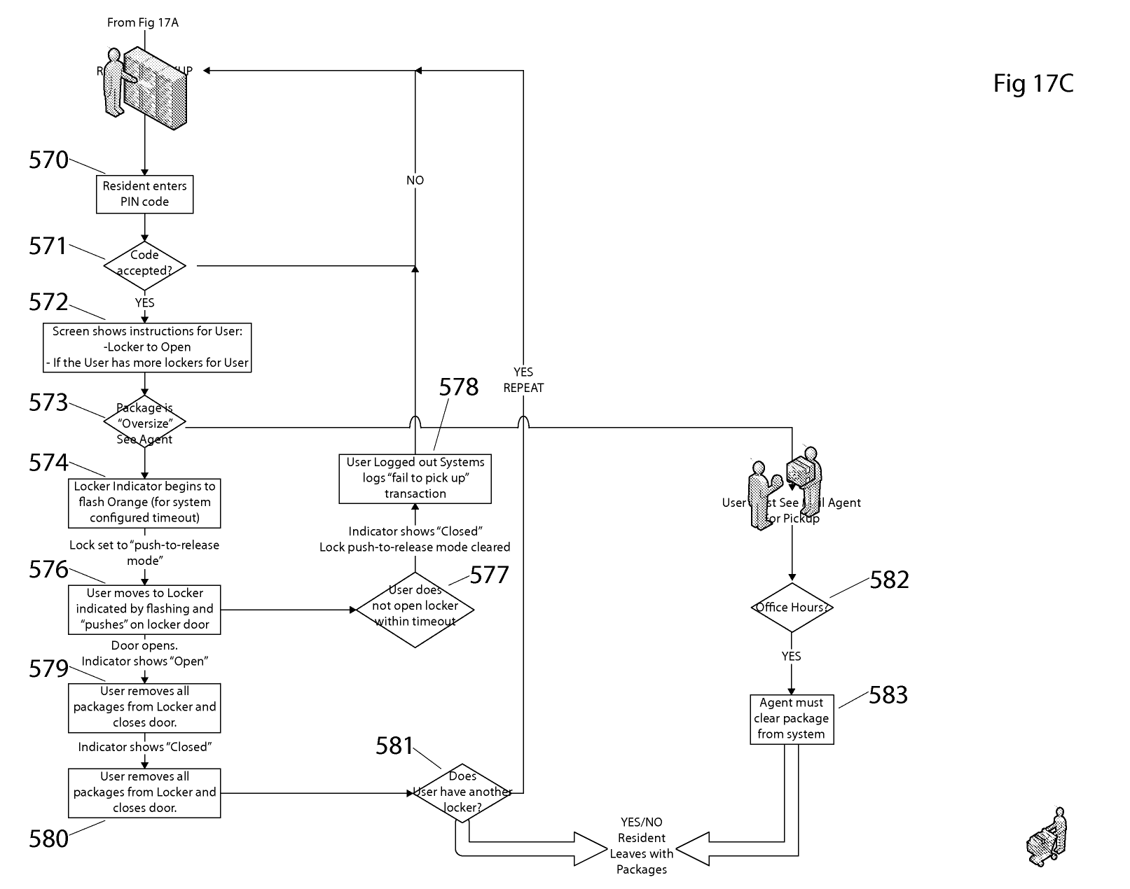

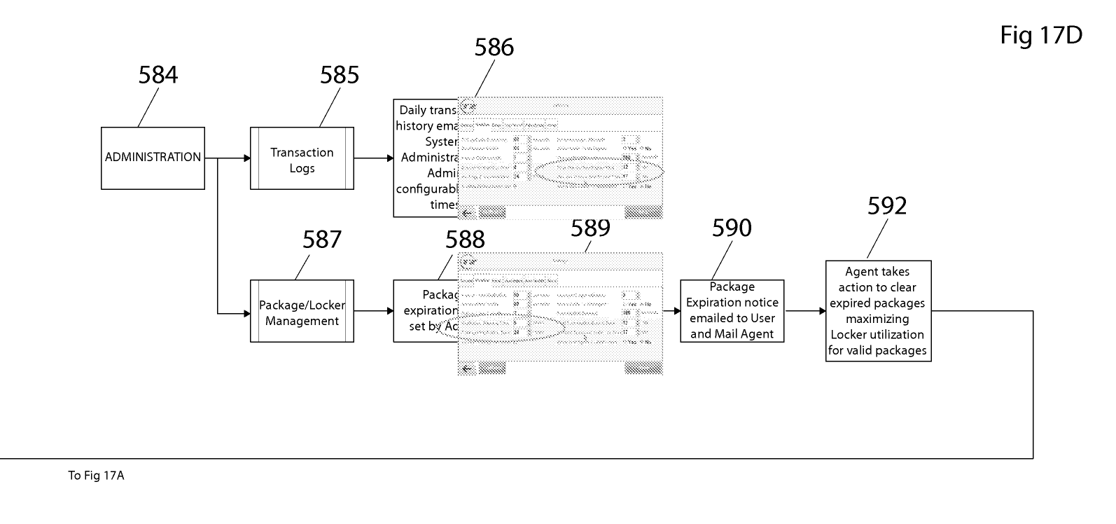

Referring now to FIGS. 17A-D one example of controlling access to one or more secured areas is described. It will be appreciated that this example illustrates embodiments particularly useful for an apartment building with a locker system. It will also be appreciated that the steps described for this particular example may be changed to suit the needs of the particular user and/or system. It will also be understood that the steps be applied, changed, or otherwise modified to suit the particular needs of other deployment environments or locations.

The process begins when a delivery truck (or other vehicle) delivers packages to the front desk of the apartment complex at step 502. An attendant at the front desk signs once for all packages. Alternatively, the attendant may be omitted and the delivery person can perform the delivery steps.

At step 504, if the package is too large or damaged, the attendant at the front desk can reject the package and return the package to the delivery person. In this case, the packages can be returned immediately or at a later time.

At step 506, the front desk attendant acts as a delivery agent and moves the packages to the mail room (or other location where the lockers are physically located). At step 508, the delivery agent drops off the packages at the locker system. There need be no dedicated employee at the locker system to receive the packages. However, all employees may act as an agent for drop off as needed.

At step 510, the package drop-off process begins. The agent may begin at either steps 512 or 514.

At step 512, an agent “badges-in” with an RFID card. At this step, a card presented by the agent is read by an RFID reader device and a determination is made if the agent is a legitimate agent. Control continues at step 516, where it is determined if the RFID badge is accepted. If the answer at step 516 affirmative, then execution continues at step 522. If the answer at step 516 negative, execution continues at step 514.

At step 514, the “agent” option is selected at the keypad. For example, the agent presses an icon on the touch screen to provide this option. At step 518, the agent enters login (e.g., user name information) and a password and it is determined if the login information has been accepted. If the answer is negative at step 518, control returns to step 514. If the answer is affirmative at step 518, control continues at step 520 where it is determined if the password is accepted. If the answer at step 520 is negative, execution continues at step 514. If the answer at step 520 is affirmative, execution continues at step 522 where the agent selects options for “drop off,” “packages” or “log off,” if “log-off” is selected, then control returns to step 514. Otherwise control continues at step 524.

At step 524, the “drop-off” option is selected and one or more of the apartment number, first name, and second name are filled in at the touch screen by the agent. Two paths, one beginning at step 526 and the other with step 528, may be followed.

If the path beginning at step 526 is followed, the agent enters the apartment number. In many of these examples, the apartment number is alphanumeric. A user list may also auto filter as the apartment number is entered (such that as particular characters are entered, entries with those characters are displayed). At step 530, the apartment number is selected (or step 532 is followed where the user is selected from a list). At step 534, the primary resident of the apartment may be selected automatically. Execution continues at step 538.

If the path beginning at step 528 is followed, the agent enters the recipient's name. Auto-filtering may also occur at this step. At step 532, the user may be selected from the user list. At step 536, it is determined if the user is on the list. If the answer is negative, control returns to step 530. If the answer is affirmative, control continues at step 538.

At step 538, the package size is selected by the agent. Some package size options include envelope, small, medium, large or oversize. Alternatively, dimensions and/or weights can be entered. Other options are possible.

If the package is “oversize,” at step 540 package is placed somewhere besides the lockers. At step 541, the screen flow jumps to show confirm drop-off that is high-lighted. Control continues at step 564.

If the package is not “oversize,” at step 542, it is determined if the resident already has a package of the same size or larger that has been recorded by the system as being stored in the lockers. If the answer is negative, at step 548, it is determined if thereare any empty lockers. At step 552, an empty locker is opened and control continues at step 554.

If the the answer at step 542 is affirmative, at step 544 it is determined if the locker is full. If the answer is negative, execution continues at step 550 and if the answer is affirmative, control continues at step 546.

At step 550, the recipient's unfilled locker is opened and the package can be placed there by the agent. Execution continues at step 554.

At step 546, it is determined if the resident has another assigned locker that is not full. If the answer is negative, execution continues with step 548. If the answer at step 546 is affirmative, execution continues at step 550.

At step 554, it is determined if the package fits in the locker. In this respect, the agent may attempt to fit the package into the locker. If the answer is negative at step 554, at step 556 the agent doses the door of the locker without placing the package in the locker. At step 558, the agent may be provided the option to set the locker state as “full.” At step 560, the screen may display “open next locker.” Execution then continues at step 542 as described above.

If the answer at step 554 is affirmative, at step 562 the agent closes the locker with the package placed in the locker. At step 564, a “Confirm drop off” is displayed on the screen. The expiry time for all packages in this locker for this resident is reset to begin expiring from when the latest package that has been dropped off.

At step 566, it is determined if there is another package to drop off. If the answer is affirmative, control returns to step 538. If the answer is negative, at step 568 an email notification (or other type of notification) transmitting the access code is sent to the resident. The drop-off process is now complete.

The retrieval process is now described. At step 570, the resident enters the code that they have been provided. At step 571, it is determined if the code is accepted. This acceptance may be accomplished by comparing the code to a set of authorized codes (stored at the touch screen device in one example). If the answer is negative, control continues at step 570 and execution continues as has been described above.

If the answer at step 571 is affirmative, then at step 572 the screen shows instructions for the user to follow, for example, to identify a particular locker (or lockers) associated with the code when the user has been assigned multiple lockers.

At step 573, it is determined if the package is “oversize,” If the answer is affirmative, at step 583 the recipient goes to the agent and at step 582 the office hours of the agent may be determined by the recipient. At step 582, the agent gives the “oversize” package to the recipient and at step 583 agent clears the package from the system.

If not an “oversize” package, at step 574 the locker indicator begins to flash orange (or some other appropriate color). The lock securing the locker is set to push-to-release mode. At step 576, the recipient moves to the locker indicated by the flashing light and pushes on the door. The door opens and indicator shows “open” (for example, by displaying a different color and/or ceasing flashing). At step 577, the recipient has not opened the door within the time out period, so the indicator shows “closed” (for example, by displaying a particular color) and the lock-push-to-release mode is cleared. At step 578, the recipient is logged out and system logs failed to pick up transaction.

At step 579, after the door opens and the indicator shows open, the user removes the packages. The indicator shows “closed” and at step 580 the locker state is set to “clear.” A transaction log is updated with picked up package and with the time. At step 581, it is determined if the user has another locker. If the answer is affirmative, step 570 is executed and control continues as described above. If the answer is negative, the resident leaves the locker area/mailroom with the packages.

At step 584, the administrative process begins. It will be appreciated that the functions and sequence of functions described here with respect to the administrative function can be varied according to the particular needs of the user and the system. At step 585 transaction logs are maintained. At step 586, daily transactions histories are emailed to the system administrator.

At step 587, package and locker management process begins. At step 588, a package expiration time can be set by the administrator. This time is the time allowed by the system for the recipient to retrieve their package after a code is entered and/or after the package has been received. At step 589, an expiration warning may be emailed to the resident to prompt pick-up of the packages. At step 590, package expiration notice is mailed to the recipient. At step 592, the agent takes action to clear unclaimed packages from the locker system.

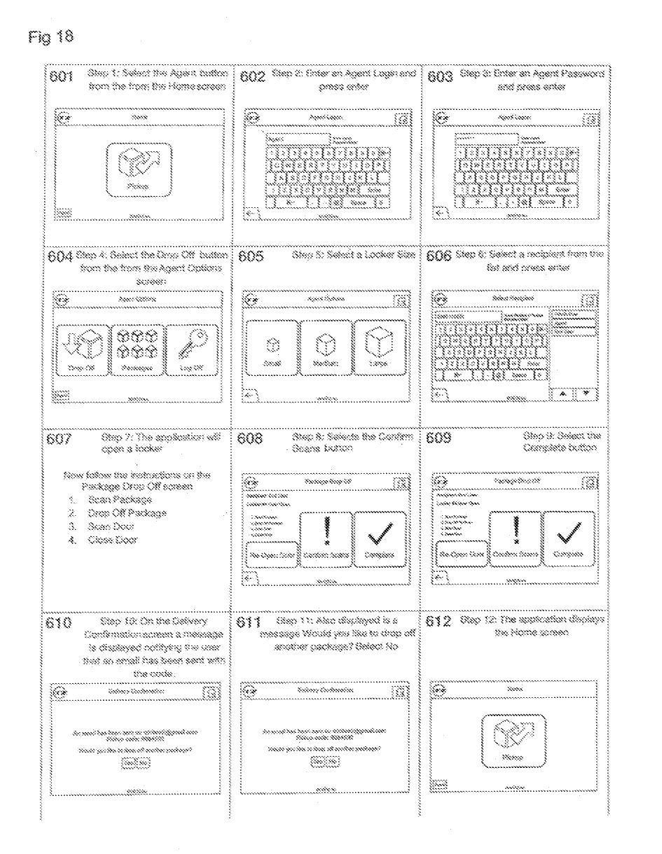

Referring now to FIG. 18, one example of touch screen displays presented to a drop-off agent is described. In this example, a package is dropped off at a locker system by the agent. The agent may be a delivery person, an attendant, or some other employee that is tasked with entering packages into the locker system. It will be appreciated that although the displays are presented as being touch-screen displays, other display or data entry units or devices (e.g., personal computers) can also be used. In addition, although this example involves the use of a locker arrangement, other storage areas can also be used. Finally, the example displays presented here are examples only and their sequence, content, and number can be varied to meet the needs of a particular user or application,

At step 601, the agent button is selected by the delivery agent from the home screen. At step 602, an agent login user name) is entered on the key pad or the touch screen. At step 603, an agent password is entered from the touch screen or the keypad. The password and user name are verified. At step 604, a drop-off option is selected on the touch screen in order to begin the drop-off process as described elsewhere herein.

At step 605, the locker size is selected by the drop-off agent At step 606, a recipient is selected from a list by the agent and “enter” is pushed on the screen by the agent. At step 607, a locker is opened by the application to allow the agent to place the package in the locker. Now, instructions are presented on the screen for the agent to scan the package, drop off the package, scan the door (to record the locker used), and close the door to the locker.

At step 608, the agent presses the confirm scan button after all scanning has been completed. At step 609, the complete button is selected and pressed by the agent. At step 610, a message is displayed notifying the agent that an email (or other message) is sent to the recipient. At step 611, a message is also displayed “Would you like to drop off another package?” In this example, the agent presses “no.” At step 612, the home screen returns and another package can be dropped oft,

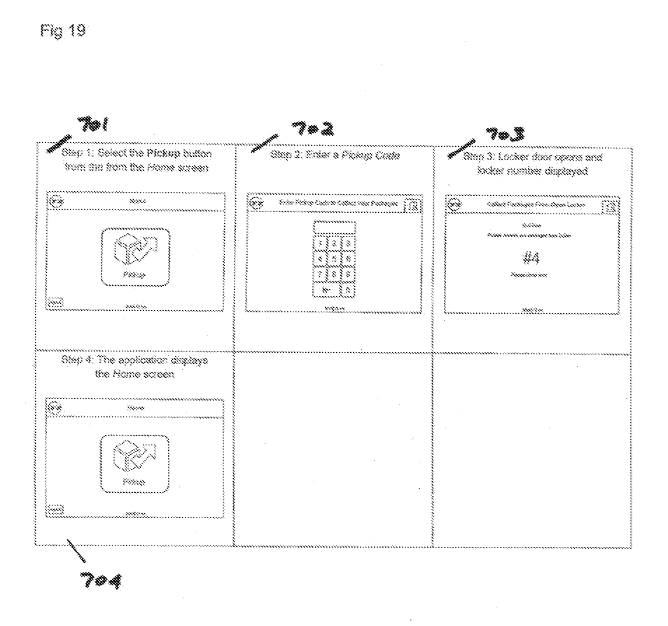

Referring now to FIG. 19, one example of screen presented to a recipient picking up packages is described. As with the example of FIG. 18, it will be appreciated that although the displays are presented as part of a touch-screen display, other display or data entry units or devices can also be used. In addition, although this example involves the use of a locker arrangement, other storage areas can also be used. Finally, the example displays presented here are examples only and their sequence, content, and number can be varied to meet the needs of a particular user or application.

At step 701, the pickup button is selected from the home screen by the recipient. In this example, a package is dropped off at a locker system by an agent and the recipient has arrived at the locker system to retrieve their package(s). At step 702, the recipient enters the pickup code that has been sent to them. At step 703, after the code has been verified, the locker door opens and the locker number is displayed on the touch screen. Additionally an indicator at the actual locker may be activated to identify the locker to the recipient and make retrieval of the package easier. At step 704, the home screen returns.

It will be understood that many of the approaches described herein may be implemented as computer software (e.g., computer software instructions coded according to any computer language) that operate on any computer hardware platform. The computer hardware platform may be any combination of electronic hardware components such as microprocessors or the like. Additionally, memory storage devices may be used to temporary or permanently store the various data that is used, created, processed, and/or changed according to the approaches described herein.

While the invention herein disclosed has been described by means of specific embodiments and applications thereof, numerous modifications and variations could be made thereto by those skilled in the art without departing from the scope of the invention.

### INDUSTRIAL APPLICABILITY

The invention allows the control of access to one or more secured areas. Items can be delivered to a recipient securely and easily, without the requirement of a dedicated human attendant being available to receive and/or retrieve the items. The recipient is automatically informed of the delivery of the item and provided with an access code to open the secured area and retrieve the item. Accurate records (e.g., electronic logs) may be automatically created and maintained to facilitate package tracking. The recipient can potentially retrieve the item any hour of the day and night. Since the items are stored in a secured area, theft and other such problems are substantially reduced or eliminated.

1. A system for controlling access for a storage enclosure, the storage enclosure having one or more walls and an opening defined by at least one of the walls, a closure for the opening and a fastener adapted to hold the closure in a closed position relative to the opening and adapted to allow the closure to assume an open position relative to the opening upon receipt of a suitable signal, the system including a user interface adapted to enable the suitable signal to be received by the fastener upon entry of an access code, means for generating the access code after delivery of an item into the storage enclosure, and means for transmitting the access code to a recipient for the item.

2. The system of claim 1, wherein the means for transmitting the access code are electronic.

3. The system of claim 1, wherein the closure is a door or drawer.

4. The system of claim 1, wherein the fastener includes shape memory alloy wire.

5. The system of claim 1, wherein the user interface is a touch-sensitive computer screen.

6. The system of claim 1, which includes means to monitor and log access to the enclosure.

7. The system of claim 1, wherein the access code is a telephone number of the recipient.

8. The system of claim 1, which includes a sensor for sending delivery or removal of the item within the enclosure.

9. The system of claim 1, which includes an indicium to identify the enclosure.

10. The system of claim 9, wherein the indicium is a light.

11. The system of claim 1, wherein the enclosure is mobile.

12. The system of claim 1, wherein the enclosure is one of an array of enclosures.

13. The system of claim 12, wherein the enclosure is of a different size to at least one other enclosure in the array.

14. In a system for controlling access for a storage enclosure, the storage enclosure having one or more walls and an opening defined by at least one of the walls, a closure for the opening and a fastener adapted to hold the closure in a closed position relative to the opening and adapted to allow the closure to assume an open position relative to the opening upon receipt of a suitable signal, a shelf for the storage enclosure, wherein the fastener is mounted on or in the shelf and the shelf is adjustable.

15. A storage enclosure retrofitted with the shelf of claim 14.

16. The shelf of claim 14, wherein the system includes a user interface adapted to enable the suitable signal to be received by the fastener upon entry of an access code, means for generating the access code after delivery of an item into the storage enclosure, and means for transmitting the access code to a recipient for the item.

17. A storage enclosure retrofitted with the shelf of claim 15.
